(19) United States
(12) Patent Application Publication
(10) Pub. No.: US 2026/0004310 A1
(43) Pub. Date: Jan. 1, 2026

(54) AI-BASED PLATFORM FOR APPLICATION ENERGY EFFICIENCY AND CARBON EMISSION OPTIMIZATION IN INFORMATION TECHNOLOGY ECOSYSTEM

(71) Applicant: Cognizant Technology Solutions US Corp, College Station, TX (US)

(72) Inventors: Roman Nemet, Arlington, MA (US); Vernon Turner, Framingham, MA (US); John Borg Jacob, Chennai (IN)

(21) Appl. No.: 19/254,472

(22) Filed: Jun. 30, 2025

Related U.S. Application Data
(60) Provisional application No. 63/665,437, filed on Jun. 28, 2024.

(51) Int. Cl. G06Q 30/018

(52) U.S. Cl. CPC G06Q 30/018

(57) ABSTRACT

A system and method for optimizing energy efficiency and carbon emissions of software-based applications within information technology ecosystem is provided. First training data, second training data, third training data, fourth training data and input data are retrieved for training AI-based model to generate set of recommendations. Generated set of recommendations are processed by AI-based model by creating vector embeddings. Verified set of generated recommendations are compared against desired set of recommendations to obtain modified set of recommendations. Workload data, real-time monitoring data, benchmark data and set of emission data are fetched. Estimated carbon footprint data and estimated energy consumption data are generated based on modified set of recommendations, workload data, monitoring data, benchmark data and set of emission data. Output data is generated based on generated estimated carbon footprint data and estimated energy consumption data for validating technologies, hardware and cloud services relating to sustainability and energy consumption.

### FIELD OF THE INVENTION

The present invention relates generally to the field of application energy efficiency and carbon emission optimisation, and more particularly the present invention relates to an artificial intelligence-based platform for application energy efficiency and carbon emission optimisation in an information technology ecosystem.

### BACKGROUND OF THE INVENTION

Typically, in an information technology ecosystem, software-based applications frequently face performance bottlenecks due to inefficient coding techniques, poor resource management, and suboptimal hardware utilization. This results in decreased response times and reduced efficiency, thereby adversely affecting user experience and overall operations. Furthermore, as software systems evolve, they tend to increase in complexity which leads to higher maintenance costs, greater risk of errors, and complications in implementing updates or integrating with other systems. Moreover, software applications are not optimized for energy consumption, leading to excessive use of electricity and power. This not only raises operational costs but also contributes to environmental degradation.

Also, software-based applications are updated, upgraded or completely changed for number of reasons such as functional requirements, performance, cost, etc. In present times, sustainability has become more important due to increased data processing, artificial intelligence (AI), analytics and storage requirements for Information Technology (IT) infrastructure that consumes more electricity.

IT systems are major consumers of energy, contributing to rising operational costs and environmental concerns. Existing approaches to software optimization often focus on improving performance through increased hardware resources or code refactoring. However, existing methods neglect impact on energy consumption and complexity reduction and cost optimization are often addressed as separate issues leading to lost opportunities for a more holistic approach.

In view of the above drawbacks, there is a need for an artificial intelligence-based platform for application modernization and energy efficiency optimization of information technology environment. There is a need for optimising energy efficiency while maintaining or improving other critical factors in IT systems. There is a need for providing a comprehensive approach to optimize software based applications, thereby enhancing operational performance, reducing associated costs, and significantly mitigating environmental impact.

### SUMMARY OF THE INVENTION

A system for optimizing energy efficiency and carbon emissions of software-based applications within an information-technology ecosystem is provided. The system comprises a memory storing program instructions and a processor executing program instructions stored in the memory and configured to execute an energy optimisation engine. The energy optimization engine is configured to retrieve a first training data, a second training data, a third training data, a fourth training data and a user input data for training an Artificial Intelligence (AI)-based model to generate a set of recommendations. The energy optimization engine processes, using the AI-based model, the generated set of recommendations by creating vector embeddings. The energy optimization engine compares a verified set of the generated recommendations against a desired set of recommendations to obtain a modified set of recommendations. Further, the energy optimization engine fetches a workload data, real-time monitoring data, benchmark data and a set of emission data. The energy optimization engine then generates an estimated carbon footprint data and estimated energy consumption data based on the modified set of recommendations, the workload data, monitoring data, benchmark data, and the set of emission data. Yet further, the energy optimization engine generates an output data based on the generated estimated carbon footprint data and estimated energy consumption data for validating technologies, hardware and cloud services relating to sustainability and energy consumption.

A method for optimizing energy efficiency and carbon emissions of software-based applications within an information-technology ecosystem is provided. The method comprises the step of retrieving a first training data, second training data, third training data, fourth training data and a user input data for training an AI-based model to generate a set of recommendations. The method comprises processing the generated set of recommendations by creating vector embeddings using the AI-based model. Further, the method comprises comparing a verified set of generated recommendations against a desired set of recommendations to obtain a modified set of recommendations. The method comprises fetching a workload data, real time monitoring data, benchmark data and a set of emission data. Also, the method comprises generating an estimated carbon footprint data and estimated energy consumption data based on the modified set of recommendations, the workload data, monitoring data, benchmark data, and the set of emission data. Yet further, the method comprises generating an output data based on the generated estimated carbon footprint data and estimated energy consumption data for validating technologies, hardware and cloud services relating to sustainability and energy consumption.

A computer program product comprising a non-transitory computer-readable medium having computer-readable program code stored thereon is provided. The computer-readable program code comprises instructions that, when executed by a processor, cause the processor to retrieve a first training data, second training data, third training data, fourth training data and a user input data for training an AI-based model to generate a set of recommendations. The processor processes the generated set of recommendations by creating vector embeddings using the AI-based model. Further, the processor compares a verified set of the generated recommendations against a desired set of recommendations to obtain a modified set of recommendations. Furthermore, the processor fetches a workload data, real time monitoring data, benchmark data and a set of emission data. Further, the processor generates an estimated carbon footprint data and estimated energy consumption data based on the modified set of recommendations, the workload data, monitoring data, benchmark data, and the set of emission data. Yet further, the processor generates an output data based on the generated estimated carbon footprint data and estimated energy consumption data for validating technologies, hardware and cloud services relating to sustainability and energy consumption.

### BRIEF DESCRIPTION OF THE ACCOMPANYING DRAWINGS

The present invention is described by way of embodiments illustrated in the accompanying drawings wherein:

FIG. 1 is a block diagram of a system for application energy efficiency and carbon emission optimization in information technology ecosystem, in accordance with an embodiment of the present invention;

FIG. 2a illustrates first training data, in accordance with an embodiment of the present invention;

FIG. 2b illustrates input categories for the first training data, in accordance with an embodiment of the present invention;

FIG. 3 illustrates examples of grid emission factors, in accordance with an embodiment of the present invention

FIG. 4 illustrates examples of cloud services carbon footprints, in accordance with an embodiment of the present invention;

FIG. 5 illustrates examples of power consumption, in accordance with an embodiment of the present invention;

FIG. 6 illustrates benchmark results summary, in accordance with an embodiment of the present invention;

FIG. 7 illustrates a set of recommendations, in accordance with an embodiment of the present invention;

FIG. 8-10 illustrates output data, in accordance with an embodiment of the present invention;

FIG. 11a-11b illustrates a method for application energy efficiency and carbon emission optimization, in accordance with an embodiment of the present invention; and

FIG. 12 illustrates an exemplary computer system in which various embodiments of the present invention may be implemented.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

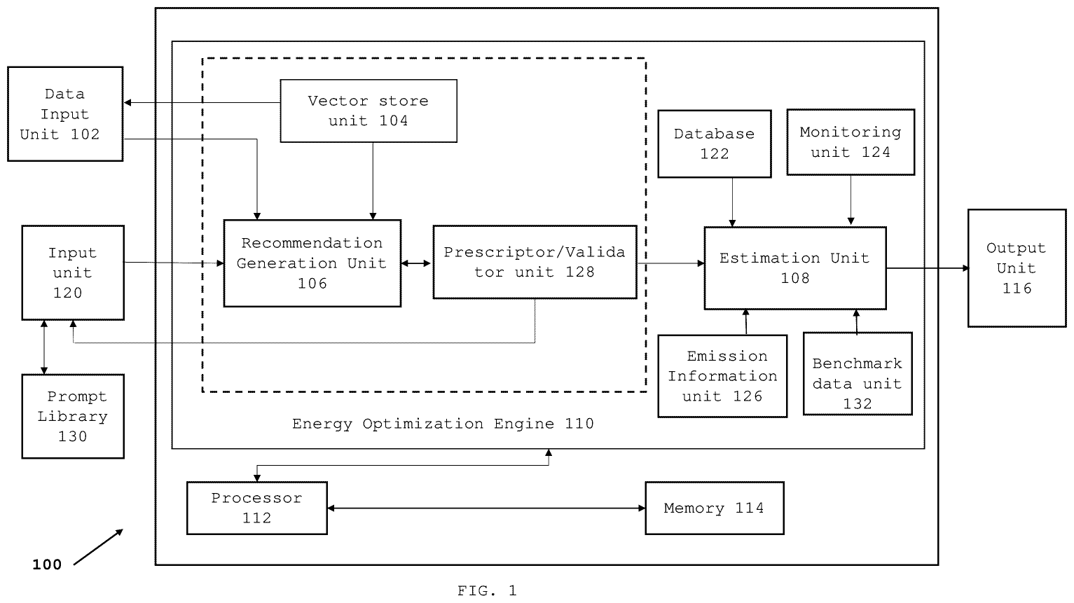

FIG. 1 is a block diagram of a system 100 for application energy efficiency and carbon emission optimisation in information technology ecosystem, in accordance with various embodiments of the present invention. The system 100 generates actionable recommendations that helps in reducing adverse environmental impact of software-based applications in the IT environment.

In an embodiment of the present invention, the system 100 comprises a data input unit 102, a user input unit 120, a prompt library 130, an energy optimisation engine 110 and an output unit 116. The energy optimisation engine 110 comprises a vector store unit 104, a recommendation generation unit 106, a prescriptor/validator unit 128, a database 122, a monitoring unit 124, an estimation unit 108, an emission information unit 126 and a benchmark data unit 132. In an embodiment of the present invention, the units of the system 100 operate in conjunction with each other and are operated via a processor 112 specifically programmed to execute instructions stored in a memory 114 for executing respective functionalities of the units of the system 100.

In an embodiment of the present invention, the system 100 may be implemented in a cloud computing architecture in which data, applications, services, and other resources are stored and delivered through shared data centres. In an exemplary embodiment of the present invention, the functionalities of the system 100 are delivered to a user as Software as a Service (Saas) or Platform as a Service (PaaS) over a communication network.

In another embodiment of the present invention, the system 100 may be implemented as a client-server architecture. In this embodiment of the present invention, a client terminal accesses a server hosting the system 100 over a communication network. The client terminals may include but are not limited to a smart phone, a computer, a tablet, microcomputer or any other wired or wireless terminal. The server may be a centralized or a decentralized server. The server may be located on a public/private cloud or locally on a particular premise.

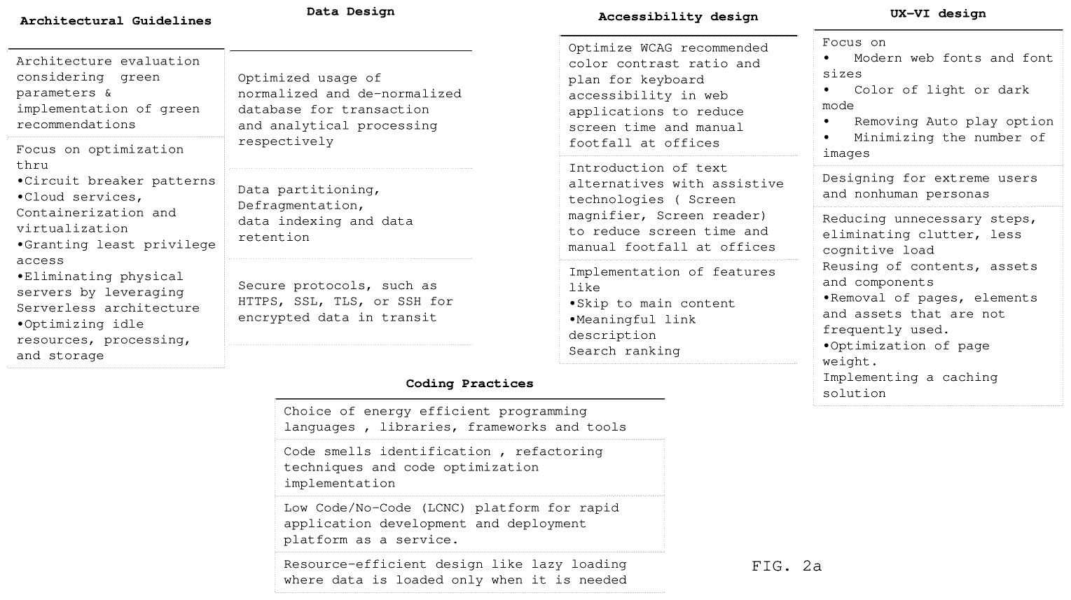

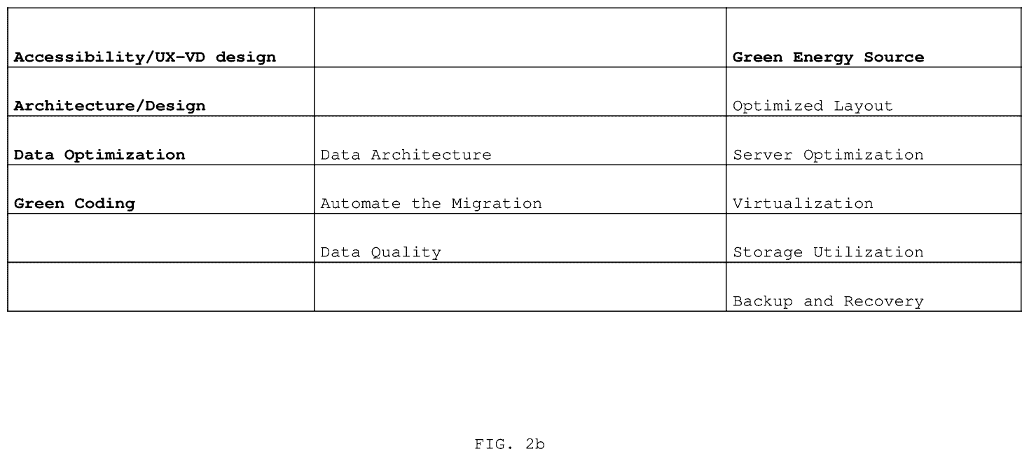

In an embodiment of the present invention, the data input unit 102 is configured to fetch a first training data from multiple data sources comprising data sources of an organization and public data pulled from various data sources. In an embodiment of the present invention, the first training data comprises data relating to a set of sustainable Information Technology (IT) practices, where each set of sustainable practice is associated with a corresponding weight that represents energy consumption information. In an embodiment of the present invention, the first training data may include data relating to, but not limited to, architectural guidelines, data design, accessibility design and UX-VI design. In an example, FIG. 2a illustrates the first training data relating to architectural guidelines, data design, accessibility design, UX/VI design and coding practices, in accordance with an embodiment of the present invention. In another example, FIG. 2b illustrates input categories for the first training data, in accordance with an embodiment of the present invention.

In an embodiment of the present invention, the data input unit 102 is configured to fetch a second training data from multiple data sources comprising data sources of an organization and public data pulled from various data sources. The second training data comprises data related to one or more functional requirements. The second training data may be in the form of user story mapping data for identifying and understanding end-user's requirements. In another embodiment of the present invention, the second training data may be in form of use case diagrams that aid in visualising interactions between actors (users, external systems) and the system 100. In another embodiment of the present invention, the second training data may be in form of sequence diagrams that depict interactions between objects or components over time.

In another embodiment of the present invention, the second training data may be in the form of wireframe and User Interface (UI) mock-ups that aid in visualising UI designs. In yet another embodiment of the present invention, the second training data may be in the form of process maps and flowcharts that aid in representing processes, workflows and decision points. In yet another embodiment of the present invention, the second training data may be in form of mind maps that aid in organising and exploring complex ideas. In another embodiment of the present invention, the second training data may be in the form of system context diagrams that depict system's 100 boundaries and external interactions. In yet another embodiment of the present invention, the second training data may be in form of functional decomposition diagrams that aid in breaking down high-level functions into smaller components. In an example, the second training data is illustrated herein below:
User Authentication and Authorization:
   Users may be able to register, log in, and manage their profiles securely.
   Admins may have additional privileges for managing products, orders, and user accounts.
Product Catalog:
   Display product listings with details (name, price, description, images).
   Allow users to search, filter and sort products.
Shopping Cart and Checkout:
   Users may add items to their cart, view the cart, and proceed to checkout.
   Implement payment gateways for secure transactions.
Order Management:
   Admins may process orders, update order status and handle returns.
User Reviews and Ratings:
   Users may leave reviews and rate products.
   Display average ratings and sort products based on reviews. Notifications:
   Send order confirmation emails, shipping updates, and promotional notifications.

In an embodiment of the present invention, the data input unit 102 is configured to fetch a third training data from multiple data sources comprising data sources of an organization and public data pulled from various data sources. The third training data may be in form of instructions associated with non-functional requirements. In an exemplary embodiment of the present invention, the third training data may include instructions for performance data type relating to performance in terms of handling of concurrent user requirements efficiently. In an example, the instruction may be ‘page load times should be minimal’. In another exemplary embodiment of the present invention, the third training data may include instructions in terms of scalability parameters such that system architecture may accommodate increased traffic during peak seasons (e.g. black Friday). In yet another exemplary embodiment, the third training data may include instructions in terms of security inputs such as implementation of secure authentication mechanisms (e.g. OAuth, JWT). The security inputs may protect against Structured Query Language (SQL) injection, cross-site scripting (XSS), and other vulnerabilities.

In another exemplary embodiment of the present invention, the third training data comprises instructions for improving reliability that helps in minimising downtime by using redundant server and failover mechanisms. In an example, the instructions for improving reliability may include regularly backing up data to prevent data loss. In yet another embodiment of the present invention, the third training data comprises instructions in terms of improving maintainability of modular components for easy updates and related bug fixes. In another exemplary embodiment of the present invention, the third training data comprises instructions for usability that relates to ensuring an initiative-based user interface (UI) with clear navigation. In yet another embodiment of the present invention, the third training data may include instructions for optimising mobile devices.

In an exemplary embodiment of the present invention, the third training data may be in the form of instructions related to UI (User Interface) design requirements. In another exemplary embodiment of the present invention, the third training data may be in form of instructions related to data requirements. In yet another exemplary embodiment of the present invention, the third training data may be in form of instructions related to system architecture patterns that relates to microservices architecture. The instructions related to system architecture may relate to breaking down of the system into smaller, independent services (e.g. user service, product service, order service etc.). In another exemplary embodiment of the present invention, the third training data may be in form of instructions for handling microservice related to a specific business capability. The microservices may communicate via Application Programming Interface (API) or message queues. In another exemplary embodiment of the present invention, the third training data may in the form of instructions including, but not limited to, containers, technology preferences (if meeting sustainability criteria), using react or angular for the front-end user interface.

In another exemplary embodiment of the present invention, the third training data may in the form of instructions for implementation of back end related task via node.js, spring boot and Django. In yet another exemplary embodiment of the present invention, the third training data may be in the form of instructions for implementing database via PostgreSQL or MongoDB. In another exemplary embodiment of the present invention, the third training data may be in form of instructions for cloud platform related to, but not limited to, deploying on Amazon Web Services (AWS) or Azure for scalability.

In an embodiment of the present invention, the data input unit 102 is configured to fetch a fourth training data from multiple data sources comprising data sources of an organization and public data pulled from various data sources. In an exemplary embodiment of the present invention, the fourth training data is in the form of instructions regarding application performance requirements. In an example, instructions for application performance requirements are provided herein below, in accordance with an embodiment of the present invention.
Performance requirements:
   R1. Product shall be able to process 100 payment transactions per second in peak load.
   R2. Product shall be able to process one alarm in 1 second, 1000 alarms in 5 seconds.
   R3. In standard work load, CPU usage shall be less than 50%, leaving 50% for background jobs.
   R4. Scrolling one page up or down in a 200 page document shall take at most 1 s. Searching for a specific keyword shall take at most 5 s.
   R5. When moving to the next field, typing must be possible within 0.2 s. When switching to the next screen, typing must be possible within 1.3 s. Showing sample report screens, less than 20 s. (Valid for 95% of the cases in standard load).
   R6. A simple report shall take less than 20 s for 90% of the cases. None shall take above 80 s. (Unrealistic)

In an embodiment of the present invention, the fourth training data comprises a data structure data that relates to energy impact in terms of high, medium and low. The data structure data includes data relating to, but not limited to, design and architecture, database, network and web. In an embodiment of the present invention, the first training data, second training data, third training data and fourth training data are fetched by the data input unit 102 in the form of organization data and public data fetched from available sources including, but not limited to, Enterprise Resource Planning (ERP) and Customer Relationship Management (CRRM). In an embodiment of the present invention, the training data relates to sustainable IT practices.

In an embodiment of the present invention, the data input unit 102 is configured to pre-process the first training data, second training data, third training data and the fourth training data (training data) via normalisation, cleaning and formatting to ensure that the training data is accurate, consistent, and usable. Advantageously, process of cleaning, formatting, and normalization of the training data is critical for ensuring that the training data is reliable and standardized. By correcting errors, unifying data representations, and transforming the training data into consistent formats, the pre-processing step implemented by the input data 102 significantly improves quality and reliability of data-driven decision-making. For example, standardizing date formats in the training data may involve converting all dates in the data to a uniform format, such as “YYYY-MM-DD” (e.g., “2025 Jun. 3”).

In an of present embodiment the invention, the recommendation generation unit 106 is configured to receive an input data from a user in the form of a natural language query via the user input unit 120. In an exemplary embodiment of the present invention, the natural language query may be in the form of a prompt. is an electronic device capable of rendering a Graphical User Interface (GUI) and displaying dashboards. The electronic device may include, but is not limited to, a computer, a laptop, a smartphone and a tablet. The user input unit 120 is connected to a prompt library 130. The prompt library 130 includes a set of pre-defined queries on relevant areas. The prompt library 130 provides the set of predefined queries for the user that the user may select based on one or more areas of interest for modifying the natural language queries based on the predefined queries stored in the prompt library 130.

In an embodiment of the present invention, the recommendation generation unit 106 receives the first, second, third and fourth training data from the data input unit 102 and the user input from the user input unit 120 for training an Artificial Intelligence (AI) based model executed by the recommendation generation unit 106 to generate a set of recommendations. In an exemplary embodiment of the present invention, the AI-based model includes generative AI based models and large language models. The set of recommendations are generated by the recommendation generation unit 106 using the training data and corresponding assigned weights representing energy consumption information, and the user input. In an embodiment of the present invention, the assigned weights (energy consumption levels-low, medium, high) are in terms of information generated by hardware manufacturers, software technology research and benchmarking, empirical experience that are gathered and collated in best practices documents as semi-structured data. In an exemplary embodiment of the present invention, the training data may be modified by a user through one or more iterations.

In an embodiment of the present invention, the set of recommendations comprises a first recommendation data. The first recommendation data include, but are not limited to, recommendations relating to identifying optimal architecture/design, cloud/on premise deployment, microservice/container-based deployment, monolithic/distributed deployment, UI/UX designs and web designs. In another embodiment the 44 of present invention, the set of recommendations comprises a second recommendation data. The second recommendation data include, but are not limited to, recommendations relating to utilising sustainable technology for server types, hardware equipment, server brand, software, database, middleware.

In yet another embodiment of the present invention, the set of recommendations comprises a third recommendation data. The third recommendation data include, but are not limited to, recommendations related to developing and implementing software-based applications with respect to parameters such as, but not limited to, complexity, performance and cost. In an embodiment of the present invention, the set of recommendations comprises a fourth recommendation data. The fourth recommendation data limited to, include, but are not recommendations for selecting coding language and techniques for coding per language.

In another embodiment of the present invention, the set of recommendations comprises a fifth recommendation data. The fifth recommendation data include recommendations related to optimised storage resource types suitable for improving functional and performance requirements. In another embodiment of the present invention, the set of recommendations comprises a sixth recommendation data. The sixth recommendation data include information related to compute parameter for computing resource types suitable for improving functional and performance requirements.

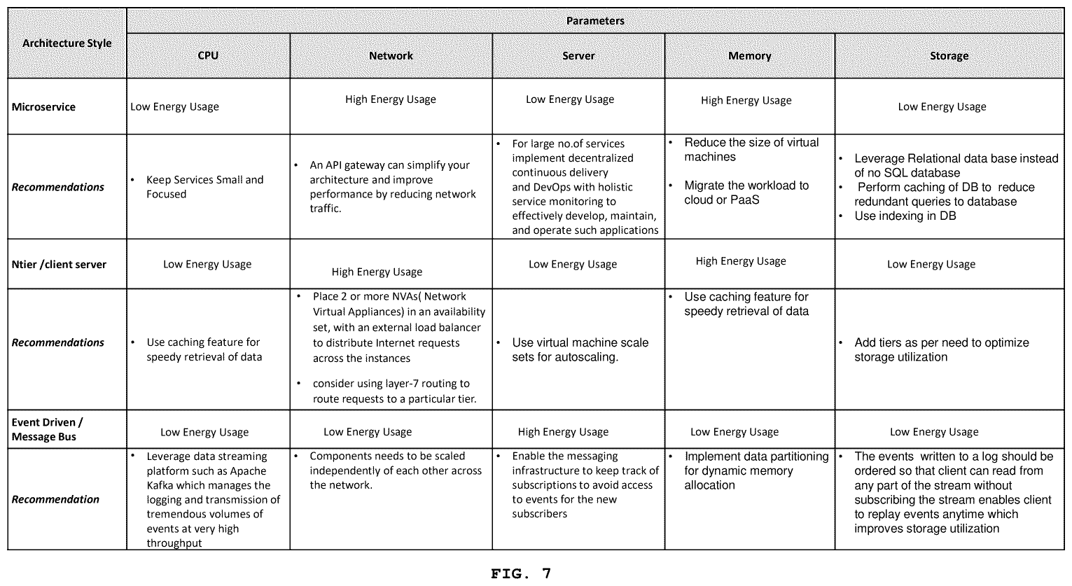

In another embodiment of the present invention, the set of recommendations comprises a seventh recommendation data. The seventh recommendation data include information relating to sustainable cloud service operation for providing recommendations on using cloud services for improving efficiency. In an example, some of the Machine Learning (ML) services may be more efficient than others. In an example, FIG. 7 illustrates a set of recommendations, in accordance with an embodiment of the present invention.

In an embodiment of the present invention, the recommendation generation unit 106 is configured to process the generated set of recommendations using, but are not limited to, Retrieval Augmented Generation (RAG) vector stored in the vector store unit 104 or graph RAG structured data such as knowledge graphs. The recommendation generation unit 106 is configured to integrate capabilities of one or more retrieval systems via RAG with the AI-based model. In an embodiment of the present invention, the recommendation generation unit 106 is configured to retrieve relevant information from external databases or knowledge sources via RAG and subsequently utilizes the AI-based model to generate informed and contextually accurate responses. This methodology ensures that output of the AI-based model relates to real-world data, thereby enhancing reliability and minimizing risk of hallucinations. In an example, the recommendation generation unit 106 uses RAG to function as a research assistant, where the AI-based model retrieves articles or data from one or more repositories and summarizes key insights for the user.

a) In an exemplary embodiment of the present invention, the AI-based model in the recommendation generation unit 106 uses RAG to gather external information. The RAG is configured to enhance accuracy and reliability of the AI based model using information fetched from specific and relevant external data sources. The RAG is configured to pull information text from latest technical journals, web sources, data bases, etc. For example, RAG fetches information from knowledge bases which include structured datasets like Wikipedia®, encyclopaedia, or scientific databases that provide verified and comprehensive information, and documentations such as one or more company manuals, product guides, or Application Programming Interface (API) based references that may be used to answer technical or domain-specific queries.

In an embodiment of the present invention, the AI-based model is trained using RAG based on industry best practices to select optimal architecture configurations, embedding techniques, and vector storage solutions. The AI-based model is configured to intelligently filter Using RAG, the AI-model is configured to achieve fine-tuning of recommendations by integrating advanced retrieval mechanisms with dynamic adjustments of the AI-based model. Specifically, RAG leverages vector embeddings to capture complex semantic relationships, systematically filters external data, and continuously updates the AI-based model based on real-world data and user feedback. This methodology ensures that the recommendations produced are highly accurate, contextually relevant, and precisely tailored to unique requirements of an organization. In the context of RAG, fine-tuning refers to a process of adapting and optimizing a pre-trained generative model to perform specialized tasks or address specific domains by utilizing domain-specific data or requirements. This process significantly enhances the AI-based model's capability to retrieve and generate highly relevant and precise information, ensuring its outputs are closely aligned with the intended application.

In an exemplary embodiment of the present invention, the AI-based model is used to create embeddings in the form of one or more vectors where the embeddings refer to dense, continuous vectors that represent text in a high-dimensional space. The one or more vectors serve as coordinates in a semantic space, capturing relationships and meanings between words. Advantageously, the embeddings aid the recommendation generation unit 106 to understand and retrieve most suitable information. The embeddings capture semantic relationships beyond mere word presence, enabling the recommendation generation unit 106 to identify and retrieve content that a literal text search might overlook. In another embodiment of the present invention, various types of embeddings are utilized, including, but not limited to, Word2Vec, GloVe, or BERT embeddings.

In an embodiment of the present invention, the AI-based model is configured to break down documents into semantically cohesive chunks based on the vector embedding. In an example, an algorithm such as sentence-BERT may be used to generate the vector embeddings for individual sentences, facilitating identification of semantically dense chunks. In another embodiment of the present invention, the vector embeddings are configured to retrieve text chunks from an external database, which is subsequently converted back into a readable format and combined with the original user prompt in the recommendation generation unit 106 to generate an enriched prompt. The enriched prompt is fed into the AI-based model in the recommendation generation unit 106 to process the set of recommendations.

In an embodiment of the present invention, the prescriptor/validator unit 128 retrieves the generated set of recommendations from the recommendation generation unit 106 and further refines the set of recommendations. The prescriptor/validator unit 128 is configured to enhance quality of the set of recommendations by removing invalid entries and formatting the set of recommendations for consistency and clarity. In an embodiment of the present invention, the prescriptor/validator unit 128 utilizes the RAG mechanism to verify the generated set of recommendations against one or more pre-determined data sources, thereby identifying and eliminating invalid or unreliable suggestions. Typically, several factors may undermine the validity of recommendations, potentially compromising their accuracy, relevance, or reliability. In an exemplary embodiment of the present invention, the factors include inaccurate or outdated external information, insufficient fine-tuning of underlying models, bias present in the training data, security or privacy concerns and Over-reliance on single or limited data sources. By systematically addressing the above-mentioned factors, the prescriptor/validator unit 128 ensures that the final set of recommendations are robust, reliable, and aligned with the intended requirements.

In an embodiment of the present invention, the prescriptor/validator unit 128 is configured to rectify the set of recommendations in terms of semantics by sending the processed set of recommendation to the user input unit 120 to modify the verified set of recommendations on the basis of desired requirements. The modified set of recommendations are carried out by comparing the verified set of recommendations with a desired set of recommendations. The comparison result is then fed to the recommendation generation unit 106. The set of recommendations are adjusted via cyclical iterations for further processing.

In an example, the desired set of recommendations may include, but are not limited to:
1. Computing parameter recommendations: This includes recommendations related to computing resource types that are suitable for improving functional and performance requirements;
2. Sustainable cloud service operation: This includes recommendations on using cloud services for improving efficiency; and
3. Filtering external data: This includes recommendations related to fine-tuning of the generated set of recommendations by filtering out irrelevant data.

In another example, in case RAG is configured to provide book suggestions to users based on their interests, the desired set of recommendations may relate to:
1. Diversity in authorship;
2. Genre representation; and
3. User preferences.

In an example, the input data entered by the user in terms of a query in natural language at the user input unit 120 and the corresponding set of recommendations rendered at the user input unit 120 are as provided below:
Query
What is the User Interface architecture for large health care company user portal with the least carbon footprint?
Set of Recommendations
The User Interface (UI) architecture for a large healthcare company user portal with the least carbon footprint would prioritize sustainability and energy efficiency at every level of design and operation. Here are some strategies to consider:
Sustainable web design: Implementing a sustainable web design approach that minimizes energy consumption by optimizing images, using efficient coding practices, and reducing the overall data transfer during user interactions.
Efficient client-side processing: Designing the UI to do more on the client side, reducing server load and energy use. However, this must be balanced with the need to not overburden the client device, which could also lead to increased energy use.
Caching and offline capabilities: Implementing service workers for caching and offline capabilities to reduce the need for constant server requests and data transfers, which in turn reduces energy consumption.
Query
Provide more details on the items you shared
Set of Recommendations
Sustainable Web Design: Sustainable web design focuses on creating websites that are efficient, use less energy, and are hosted on eco-friendly servers. It involves:
   Efficiency in Design: Streamlined websites that load quickly and consume less energy.
      Clean Coding Practices: Efficient, well-organized code helps reduce the server's processing load, leading to lower energy consumption.
      Optimizing Images: Choosing the right format and compression to reduce the size of images without compromising quality.
      Minimizing Resource-Heavy Elements: Avoiding unnecessary scripts and plugins that add extra weight to your website.
Green hosting: Green hosting refers to web hosting that uses renewable energy sources or has a commitment to carbon neutrality.
For a healthcare portal, this could mean:
   Renewable Energy: Hosting services powered by renewable energy sources like wind or solar.
   Energy-Efficient Data Centers: Data centers designed to be more energy-efficient and have a smaller carbon footprint.
   Carbon Offsetting: Hosting providers may also engage in carbon offsetting activities to balance out their emissions.
Efficient Client-Side Processing: Efficient client-side processing can lead to faster page load times and a smoother interaction with the web application. It includes:
   Minimizing JavaScript Size: File Using minification and compression techniques to reduce the size of JavaScript files. Browser Caching: Leveraging browser caching to store frequently accessed resources on the user's device.
   Lazy Loading: Loading resources only when they are needed, which can significantly reduce initial load times.
Caching and offline capabilities: Caching and offline capabilities are essential for PWAs to function without an internet connection.
This involves:
   Service Workers: Scripts that enable PWAs to cache and serve content when the user is offline or has a poor internet connection.
   Offline Storage Technologies: Using indexed DB and other storage mechanisms to keep essential data available even when offline.
Background Sync: Allowing the app to synchronize data in the background once connectivity is restored

In another embodiment of the present invention, the prescriptor/validator unit 128 sends the processed set of recommendation to the estimation unit 108. In an embodiment of the present invention, the estimation unit 102 fetches a database workload data from the database unit 122. In another embodiment of the present invention, the estimation unit fetches a real-time monitoring data based on observation data in an IT ecosystem from the monitoring unit 124. The monitoring data is updated based on observation levels and parameters set within an organisation and a pre-set public data.

In yet another embodiment of the present invention, the estimation unit 108 fetches a benchmark data from a benchmark data unit 132. The benchmark data relates to evaluated power and performance characteristics of single server and multi-node server. The benchmark data is used to compare power and performance characteristics among different servers and serves as a toolset for improving server efficiency. In an exemplary embodiment of the present invention, the benchmark data includes server benchmark data comprising resource data in terms of parameter relating to brand, type/category of hardware, manufacturer details, memory size, CPU number and type, network connectivity type and storage size. The server benchmark data also includes energy consumption data in terms of watts with usage levels of, for example, 100%, 75%, 50%, 25%, 10%, 0%. In another exemplary embodiment of the present invention, the benchmark data includes data relating to hardware benchmark and cost associated with the hardware.

In an embodiment of the present invention, the estimation unit 108 fetches a set of emission data from the emission information unit 126. In an embodiment of the present invention, the set of emission data comprises cloud services data. In an exemplary embodiment of the present invention, the cloud services data includes resource data for compute memory, storage, network services with detail sizing and scaling. In another exemplary embodiment of the present invention, the cloud services data includes resource energy data for energy consumption in terms of watts with usage levels of, for example, 100%, 75%, 50%, 25%, 10%, 0% per service. In yet another exemplary embodiment of the present invention, the cloud service data includes emission per unit of service in terms of size, compute power and throughput. In another exemplary embodiment of the present invention, the cloud services data comprises data relating to Central processing Unit (CPU), memory, storage and network utilization.

In another embodiment of the present invention, the set of emission data comprises data relating to pre-modernisation level in case of redesigning or tech modernization. In an exemplary embodiment of the present invention, the set of emission data is aggregated on 24 hours and weekly averages. In another embodiment of the present invention, the set of emission data comprises carbon emission data The carbon emission data is generated via Software Carbon Intensity (SCI) index, where the SCI index signifies rate of carbon emissions. The SCI index is illustrated herein below:

$$SCI index = ( ( E * I ) + M ) per R$$

Where E=Energy consumed by software in kWh;
   I=Carbon emitted per kWh of energy, in gCO₂/kWh;
   M=Embodied carbon emissions from the creation (and destruction) of hardware that software is running on;
   R=Functional unit, in terms of how software scales, for example by user, device or API requests.

Advantageously, the SCI index is used for calculating a software system's carbon emissions rate. The SCI index helps in evaluation of software application's sustainability such that appropriate measures may be taken to reduce emissions. The SCI index signifies amount of carbon emitted in grams per unit. In another embodiment of the present invention, the set of data comprises cost data corresponding to one or more parameters in the set of recommendations generated by the recommendation generation unit 106. In yet another embodiment of the present invention, the set of data comprises carbon emission index information retrieved from one or more external database.

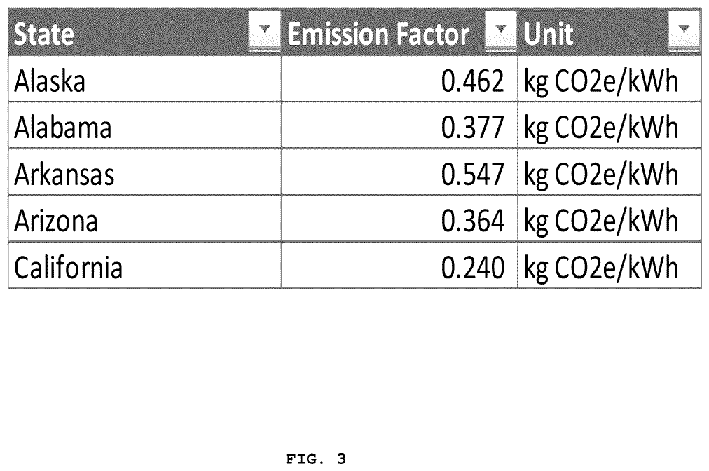

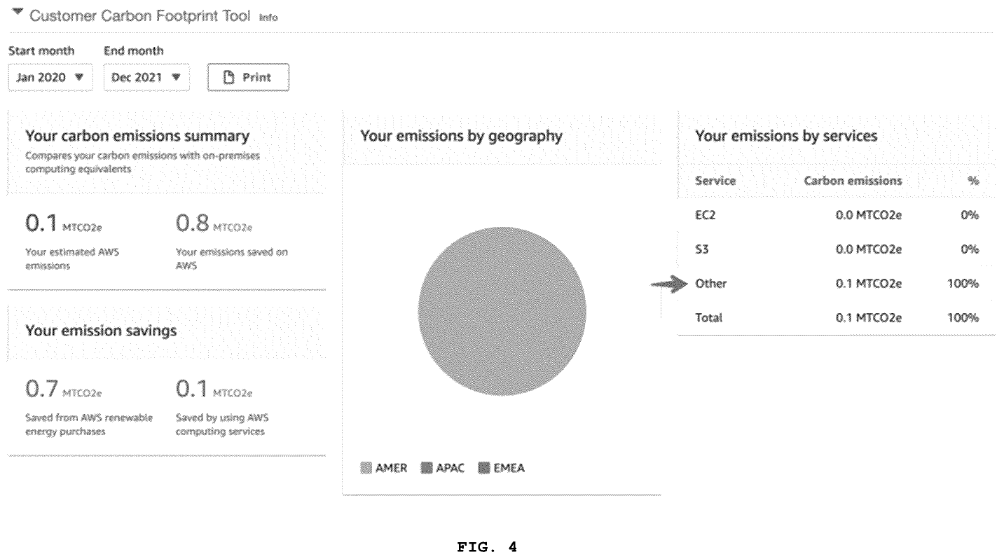

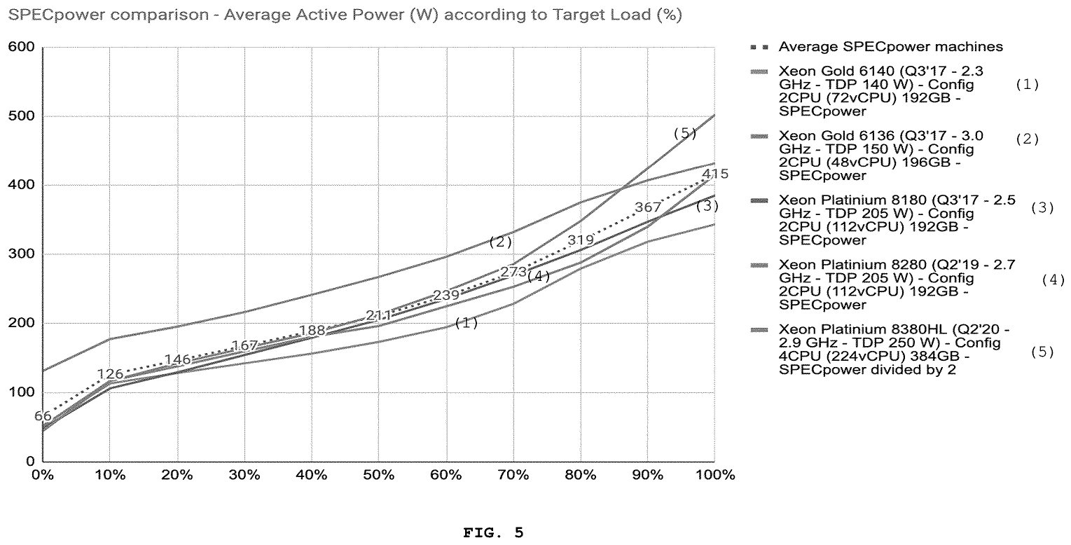

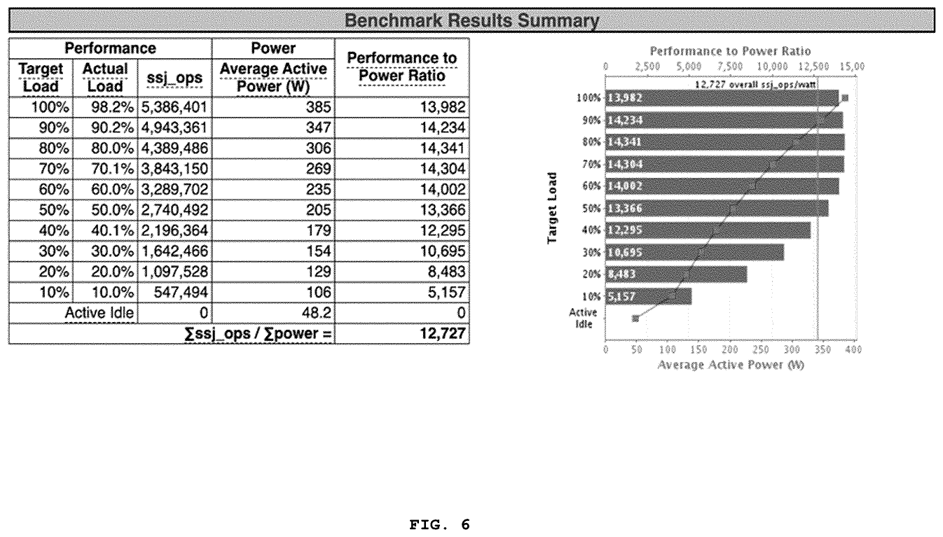

In an embodiment of the present invention, the estimation unit 108 generates an estimated carbon footprint data and estimated energy consumption data based on the set of recommendations, the database workload data, monitoring data, benchmark data, and the set of emission data. In another embodiment of the present invention, the estimation unit 108 generates estimated cost data that would be incurred while implementing the set of recommendations. In an exemplary embodiment of the present invention, the estimated cost data includes reports regarding technology stacks/services costs in terms of low, medium and high. FIG. 3 illustrates examples of grid emission factors, in accordance with an embodiment of the present invention. FIG. 4 illustrates examples of cloud services carbon footprints and FIG. 5 illustrates examples of EC2 power consumption, in accordance with an embodiment of the present invention. FIG. 6 illustrates benchmark results summary, in accordance with an embodiment of the present invention.

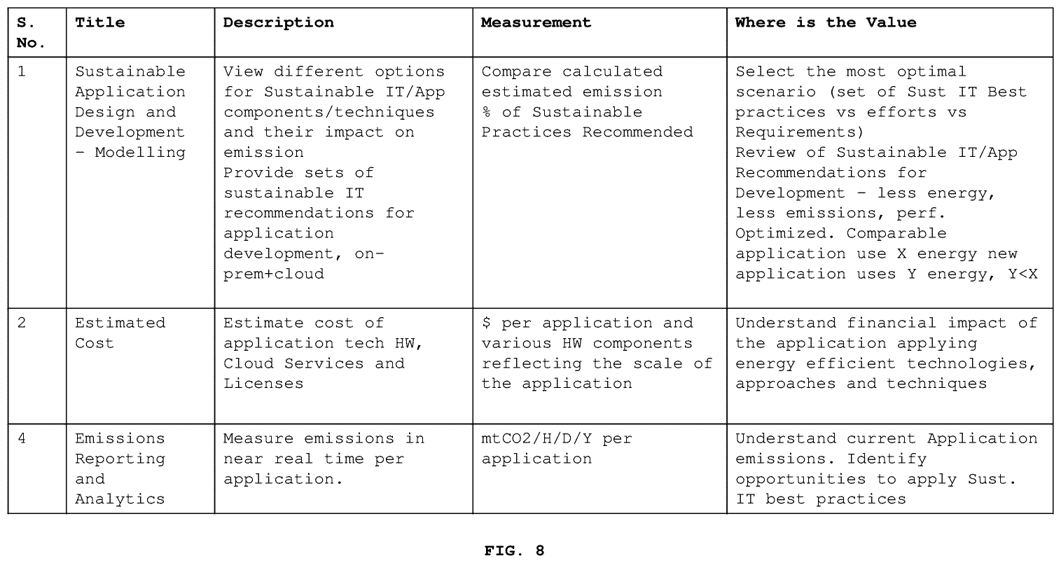

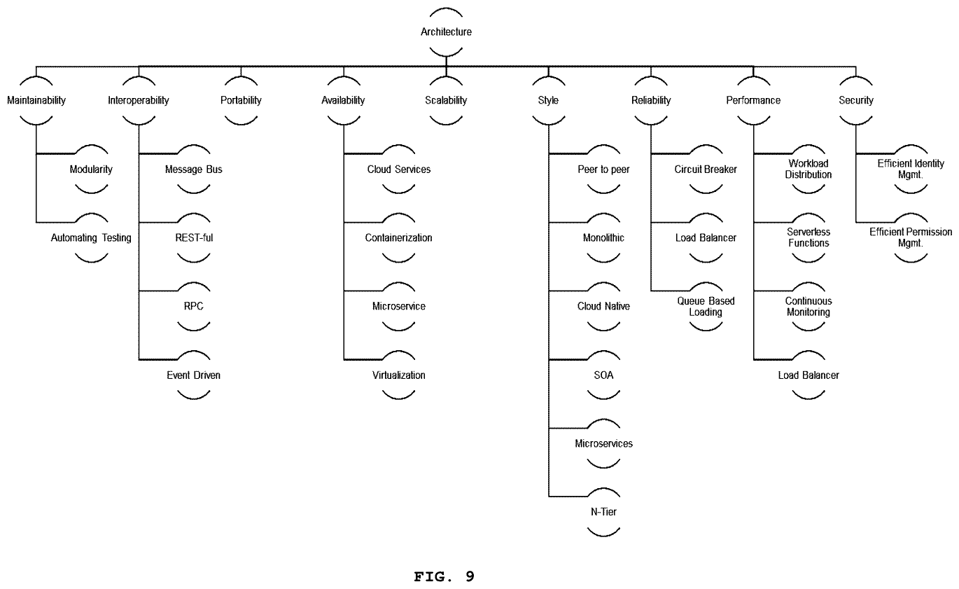

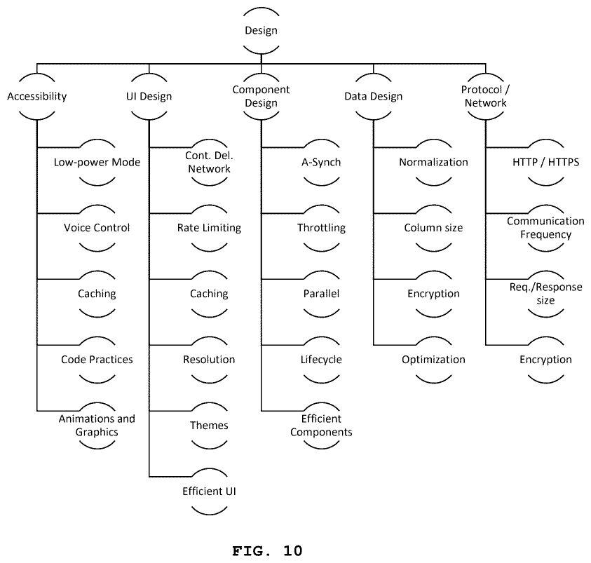

In an embodiment of the present invention, the output unit 116 is configured to fetch the estimated carbon footprint data, estimated energy consumption data and estimated cost data to generate an output data. In an exemplary embodiment of the present invention, FIG. 8-10 illustrates the output data. In an example, the generated output results data is illustrated herein below:
Performance:
The system should handle concurrent user requests efficiently. Page load times should be minimal.
Scalability:
The architecture should accommodate increased traffic during peak seasons (e.g., Black Friday).
Consider horizontal scaling (adding more servers) or cloud-based solutions.
Security:
Implement secure authentication mechanisms (e.g., OAuth, JWT).
Protect against SQL injection, cross-site scripting (XSS), and other vulnerabilities.
Reliability:
Minimize downtime by using redundant servers and failover mechanisms. Regularly back up data to prevent data loss.
Maintainability:
Use modular components for easy updates and bug fixes.
Document code and architectural decisions.
Usability:
Ensure an intuitive user interface (UI) with clear navigation. Optimize for mobile devices.
Architecture Pattern:
   Microservices Architecture:
      Break down the system into smaller, independent services (e.g., user service, product service, order service).
      Each microservice handles a specific business capability. Communicate via APIs or message queues.
Containers

In an embodiment of the present invention, the output results may be adjusted manually on the basis of desired requirements by comparing the generated output results with a desired set of output results. In another embodiment of the present invention, the generated output results may be adjusted via cyclical iterations.

Advantageously, the system 100 enables obtaining sustainable alternatives and validating architecture components, services and configurations of software-based applications in terms of energy efficiency based on the output data. The system 100 may be utilised by application developers and system infrastructure developers for validating technologies, hardware and cloud services with regards to sustainability and energy consumption based on the output data. Advantageously, the system 100 may be utilised as a consulting tool to optimize codes and programming techniques as per different languages.

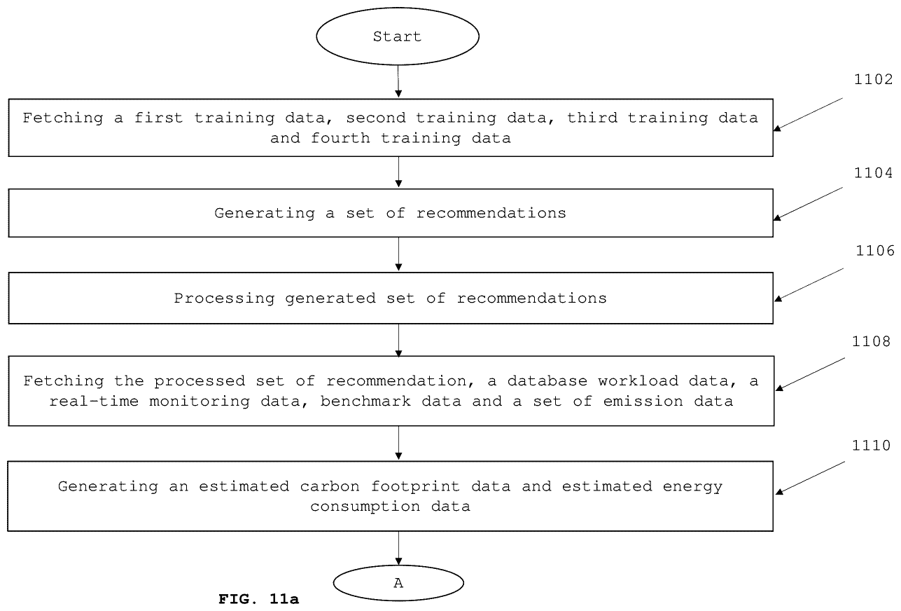

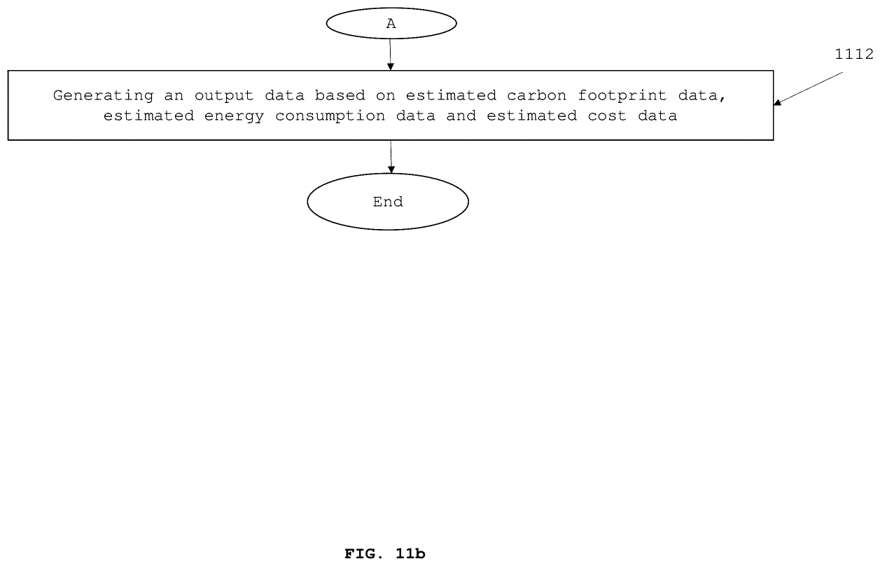

FIG. 11a-11b illustrates a method for application energy efficiency and carbon emission optimization in information technology ecosystem, in accordance with an embodiment of the present invention.

At step 1102, a first training data, a second training data, a third training data and a fourth training data are fetched. In an embodiment of the present invention, the first training data is fetched from multiple data sources of an organization and public data pulled from various data sources. The first training data comprises data relating to a set of sustainable information technology practices, where each of the sustainable practices is associated with a corresponding weight that represents energy consumption information. In an exemplary embodiment of the present invention, the first training data may include data relating to architectural guidelines, data design, accessibility design and UX-VI design.

In an embodiment of the present invention, the second training data is fetched from multiple data sources comprising data sources of an organization and public data pulled from various data sources. The second training data comprises data related to one or more functional requirements. In an exemplary embodiment of the present invention, the second training data may be in form of a user story mapping data for identifying and understanding end-user's requirements. In another exemplary embodiment of the present invention, the second training data may be in form of use case diagrams that aid in visualising interactions between actors (users, external systems) and the system. In yet another exemplary embodiment of the present invention, the second training data may be in the form of sequence diagrams that depict interactions between objects or components over time.

In another exemplary embodiment of the present invention, the second training data may be in the form of wireframe and User Interface (UI) mock-ups that aid in visualising UI designs. In yet another exemplary embodiment of the present invention, the second training data may be in the form of process maps and flowcharts that aid in representing processes, workflows and decision points. In another exemplary embodiment of the present invention, the second training data may be in form of mind maps that aid in organising and exploring complex ideas. In another exemplary embodiment of the present invention, the second training data may be in the form of system context diagrams that depict boundaries and external interactions. In yet another exemplary embodiment of the present invention, the second training data may be in form of functional decomposition diagrams that aid in breaking down high-level functions into smaller components.

In an embodiment of the present invention, the third training data is fetched from multiple data sources comprising data sources of an organization and public data pulled from various data sources. The third training data may be in form of instructions associated with non-functional requirements. In an exemplary embodiment of the present invention, the third training data may include instructions for performance data type relating to performance in terms of handling of concurrent user requirements efficiently. In an example, the instruction may be ‘page load times should be minimal’. In another exemplary embodiment of the present invention, the third training data may include instructions in terms of scalability parameters such that system architecture may accommodate increased traffic during peak seasons (e.g. black Friday). In yet another exemplary embodiment, the third training data may include instructions in terms of security inputs such as implementation of secure authentication mechanisms (e.g. OAuth, JWT). The security inputs may protect against Structured Query Language (SQL) injection, cross-site scripting (XSS), and other vulnerabilities.

In another exemplary embodiment of the present invention, the third training data comprises instructions for improving reliability that helps in minimising downtime by using redundant server and failover mechanisms. In an example, the instructions for improving reliability may include regularly backing up data to prevent data loss. In yet another embodiment of the present invention, the third training data comprises instructions in terms of improving maintainability of modular components for easy updates and related bug fixes. In another exemplary embodiment of the present invention, the third training data comprises instructions for usability that relates to ensuring an initiative-based user interface (UI) with clear navigation. In yet another embodiment of the present invention, the third training data may include instructions for optimising mobile devices.

In an exemplary embodiment of the present invention, the third training data may be in the form of instructions related to UI (User Interface) design requirements. In another exemplary embodiment of the present invention, the third training data may be in form of instructions related to data requirements. In yet another exemplary embodiment of the present invention, the third training data may be in form of instructions related to system architecture patterns that relates to microservices architecture. The instructions related to system architecture may relate to breaking down of the system into smaller, independent services (e.g. user service, product service, order service etc.). In another exemplary embodiment of the present invention, the third training data may be in form of instructions for handling microservice related to a specific business capability. The microservices may communicate via Application Programming Interface (API) or message queues. In another exemplary embodiment of the present invention, the third training data may in the form of instructions including, but not limited to, containers, technology preferences (if meeting sustainability criteria), using react or angular for the front-end user interface.

In another exemplary embodiment of the present invention, the third training data may in the form of instructions for implementation of back end related task via node.js, spring boot and Django. In yet another exemplary embodiment of the present invention, the third training data may be in the form of instructions for implementing database via PostgreSQL or MongoDB. In another exemplary embodiment of the present invention, the third training data may be in form of instructions for deployment cloud platform. Examples of cloud platform include Amazon Web Services (AWS) or Azure for scalability.

In an embodiment of the present invention, the fourth training data is fetched from multiple data sources comprising data sources of an organization and public data pulled from various data sources. In an exemplary embodiment of the present invention, the fourth training data is in the form of instructions associated with application performance requirements. The fourth training data comprises a data structure data that relates to energy impact in terms of high, medium and low. The data structure data includes data relating to, for example, design and architecture, database, network and web.

In an embodiment of the present invention, the first training data, second training data, third training data and fourth training data are fetched by the data input unit 102 in the form of organization data and public data fetched from available sources including, but not limited to, Enterprise Resource Planning (ERP) and Customer Relationship Management (CRM).

In an embodiment of the present invention, the first training data, second training data, third training data and the fourth data training (training data) are pre-processed via normalisation, cleaning and formatting. In an exemplary embodiment of the present invention, the step of pre-processing comprises cleaning, formatting, and normalizing the training data to ensure that the training data is accurate, consistent, and usable. Advantageously, process of cleaning, formatting, and normalization of the training data is critical for ensuring that the training data is reliable and standardized. By correcting errors, unifying data representations, and transforming the training data into consistent formats, the pre-processing step significantly improves quality and reliability of data-driven decision-making. For example, standardizing date formats in the training data may involve converting all dates in the data to a uniform format, such as “YYYY-MM-DD” (e.g., “2025 Jun. 3”).

At step 1104, a set of recommendations are generated. In an embodiment of the present invention, the set of recommendations are generated using the first, second, third and fourth training data and input data received from a user that is used for training the AI-based model. In an exemplary embodiment of the present invention, the AI-based model includes generative AI-based models and large language models. The input data is received in the form of a natural language query. In an exemplary embodiment of the present invention, the natural language query may be in the form of a prompt. A set of predefined queries are provided for the user to select based on one or more areas of interest for modifying the natural language queries based on the predefined queries stored in a prompt library. AI-based algorithms are executed using the training data and corresponding assigned weights representing energy consumption information, and the user input. In an embodiment of the present invention, the assigned weights (energy consumption levels-low, medium, high) are in terms of information generated by hardware manufacturers, software technology research and benchmarking, empirical experience that are gathered and collated in best practices documents as semi-structured data. In an exemplary embodiment of the present invention, the training data may be modified by a user through one or more iterations. The AI-based model is trained using a Retrieval Augmented Generation (RAG) technique with industry best practices to select optimal architecture configurations, embedding techniques, and vector storage solutions.

In an embodiment of the present invention, the set of recommendations comprises a first recommendation data. The first recommendation data include, but are not limited to, recommendations relating to identifying optimal architecture/design, cloud/on premise deployment, microservice/container-based deployment, monolithic/distributed deployment, UI/UX designs and web designs. In another embodiment of the present invention, the set of recommendations comprises a second recommendation data. The second recommendation data include, but are not limited to, recommendations relating to utilising sustainable technology for server types, hardware equipment, server brand, software, database, middleware. In yet another embodiment of the present invention, the set of recommendations comprises a third recommendation data. The third recommendation data include, but are not limited to, recommendations related to developing and implementing software-based applications with respect to parameters such as, but not limited to, complexity, performance and cost. In an embodiment of the present invention, the set of recommendations comprises a fourth recommendation data. The fourth recommendation data include, but are not limited to, recommendations for selecting coding language and techniques for coding per language. In another embodiment of the present invention, the set of recommendations comprises a fifth recommendation data. The fifth recommendation data include recommendations related to optimised storage resource types suitable for improving functional and performance requirements. In another embodiment of the present invention, the set of recommendations comprises a sixth recommendation data. The sixth recommendation data include information related to parameters for computing resource types suitable for improving functional and performance requirements. In another embodiment invention, of the present the set of recommendations comprises a seventh recommendation data. The seventh recommendation data include information relating to sustainable cloud service operation for providing recommendations on using cloud services for improving efficiency. In an example, some of the Machine Learning (ML) services may be more efficient than others.

At step 1106, the generated set of recommendations are processed. In an embodiment of the present invention, the generated set of recommendations are processed using RAG vector stored in the vector store unit. In another embodiment of the present invention, the generated set of recommendations are processed using graph RAG structured data such as knowledge graphs. In an embodiment of the present invention, capabilities of one or more retrieval systems are integrated via RAG with the AI-based model. Relevant information is retrieved from external databases or knowledge sources via RAG and subsequently the AI-based model is utilised to generate informed and contextually accurate responses. This methodology ensures that output of the AI-based model relates to real-world data, thereby enhancing reliability and minimizing risk of hallucinations.

In an embodiment of the present invention, the AI-based model uses RAG technique to gather external information which enhances accuracy and reliability of the AI-based model by using information fetched from specific and relevant external data sources. In an example, the AI-based model is configured to pull information text from latest technical journals, web sources, data bases, etc. The AI-model is configured to intelligently filter external data and fine-tune the generated set of recommendations. Using RAG, fine-tuning of recommendations is carried out by integrating advanced retrieval mechanisms with dynamic adjustments of the AI-based model. Specifically, RAG leverages vector embeddings to capture complex semantic relationships, systematically filters external data, and continuously updates the AI-based model based on real-world data and user feedback. This methodology ensures that the recommendations produced are highly accurate, contextually relevant, and precisely tailored to unique requirements of an organization. In the context of RAG, fine-tuning refers to process of adapting and optimizing a pre-trained generative model to perform specialized tasks or address specific domains by utilizing domain-specific data or requirements. This process significantly enhances the RAG's capability to retrieve and generate highly relevant and precise information, thereby ensuring its outputs are closely aligned with the intended application.

In an exemplary embodiment of the present invention, the AI-based model creates embeddings in the form of one or more vectors where the embeddings refer to dense, continuous vectors that represent text in a high-dimensional space. The one or more vectors serve as coordinates in a semantic space, capturing relationships and meanings between words. Advantageously, the embeddings aid to understand and retrieve most suitable information. The embeddings capture semantic relationships beyond mere word presence to identify and retrieve content that a literal text search might overlook. In another embodiment of the present invention, various types of embeddings are utilized, including, but are not limited to, Word2Vec, GloVe, or BERT embeddings.

In an embodiment of the present invention, AI-based model is configured to break down documents into semantically cohesive chunks based on the vector embeddings. In an example, an algorithm such as sentence-BERT may be used to create the vector embeddings for individual sentences, thereby facilitating identification of semantically dense chunks. In another embodiment of the present invention, the vector embeddings are configured to retrieve text chunks from an external database, which is subsequently converted back into a readable format and combined with the original user prompt to generate an enriched prompt. The enriched prompt is fed into the AI-based model to process the set of recommendations. In an embodiment of the present invention, the set of recommendations are retrieved and further refined by removing invalid entries and formatting the set of recommendations for consistency and clarity. The generated set of recommendations are verified against one or more pre-determined data sources, thereby identifying and eliminating invalid or unreliable suggestions. Typically, several factors may undermine the validity of recommendations potentially compromising their accuracy, relevance, or reliability such as inaccurate or outdated external insufficient information, fine-tuning of underlying models, bias present in the training data, security or privacy concerns and over-reliance on single or limited data sources. By systematically addressing the above-mentioned factors, it is ensured that the final set of recommendations are robust, reliable, and aligned with the intended requirements.

In an embodiment of the present invention, the verified set of recommendations are rectified in terms of semantics. by modifying the set of recommendations on the basis of desired requirements. The modified set of recommendations are obtained by comparing the verified set of recommendations with a desired set of recommendations, as described previously. The set of recommendations may, therefore, be adjusted via cyclical iterations for further processing.

At step 1108, the set of recommendation, a database workload data, a real-time monitoring data, a benchmark data, and a set of emission data are fetched. In an embodiment of the present invention, the monitoring data is obtained based on observation data in an IT ecosystem. The monitoring data is updated based on observation levels and parameters set within an organisation and a pre-set public data. In another embodiment of the present invention, the benchmark data relates to evaluated power and performance characteristics of single server and multi-node server. The benchmark data is used to compare power and performance characteristics among different servers and serves as a toolset for improving server efficiency. In an exemplary embodiment of the present invention, the benchmark data includes server benchmark data comprising resource data in terms of parameter relating to brand, type/category of hardware, manufacturer details, memory size, CPU number and type, network connectivity type and storage size. The server benchmark data also includes energy consumption data in terms of watts with usage levels (100%, 75%, 50%, 25%, 10%, 0%). In another exemplary embodiment of the present invention, the benchmark data includes data relating to hardware benchmark and cost associated with the hardware.

In an embodiment of the present invention, the set of emission data comprises cloud services data. In an exemplary embodiment of the present invention, the cloud services data includes resource data for compute memory, storage, network services with detail sizing and scaling. In another exemplary embodiment of the present invention, the cloud services data includes resource energy data for energy consumption in terms of watts with usage levels (100%, 75%, 50%, 25%, 10%, 0%) per service. In yet another exemplary embodiment of the present invention, the cloud service data includes emission per unit of service in terms of size, compute power and throughput. In another exemplary embodiment of t the present invention, the cloud services data comprises data relating to Central processing Unit (CPU), memory, storage and network utilization.

In another embodiment of the present invention, the set of emission data comprises data relating to a pre-modernisation level in case of redesigning or tech modernization. In an exemplary embodiment of the present invention, the set of data is aggregated on 24 hours and weekly averages. In another embodiment of the present invention, the set of emission data comprises carbon emission data which is generated via Software Carbon Intensity (SCI) index, where the SCI index signifies rate of carbon emissions. The SCI index is illustrated herein below:

$$SCI index = ( ( E * I ) + M ) per R$$

Where E=Energy consumed by software in kWh;
   I=Carbon emitted per kWh of energy, in gCO₂/kWh;
   M=Embodied carbon emissions from the creation (and destruction) of hardware that software is running on;
   R=Functional unit, in terms of how software scales, for example by user, device or API requests.

Advantageously, the SCI index is used for calculating a software system's carbon emissions rate. The SCI index helps in evaluation of software application's sustainability such that appropriate measures may be taken to reduce emissions. The SCI index signifies the amount of carbon emitted in grams per unit. In another embodiment of the present invention, the set of emission data comprises cost data corresponding to one or more parameters in the generated set of recommendations. In yet another embodiment of the present invention, the set of emission data comprises carbon emission index information retrieved from one or more external database.

At step 1110, an estimated carbon footprint data and estimated energy consumption data are generated. In an embodiment of the present invention, the estimated carbon footprint data and estimated energy consumption data are generated based on the set of recommendations, the database workload data, monitoring data, benchmark data, and the set of emission data. In another embodiment of the present invention, an estimated cost data is generated that would be incurred while implementing the set of recommendations. In an exemplary embodiment of the present invention, the estimated cost data includes reports regarding technology stacks/services costs in terms of low, medium and high.

At step 1112, an output data is generated based on the estimated carbon footprint data, estimated energy consumption data and estimated cost data. In an embodiment of the present invention, the output results, as described previously, may be adjusted manually on the basis of desired requirements by comparing the generated output results with a desired set of output results. In another embodiment of the present invention, the generated output results may be adjusted via cyclical iterations.

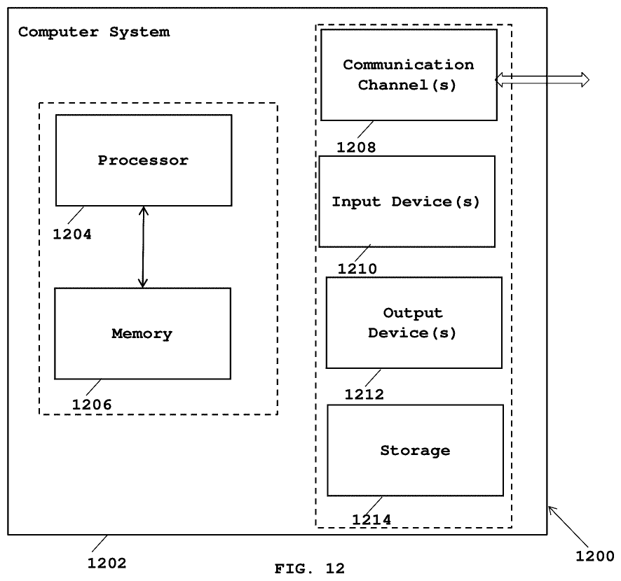

FIG. 12 illustrates an exemplary computer system in which various embodiments of the present invention may be implemented. The computer system 1202 comprises a processor 1204 and a memory 1206. The processor 1204 executes program instructions and is a real processor. The computer system 1202 is not intended to suggest any limitation as to scope of use or functionality of described embodiments. For example, the computer system 1202 may include, but not limited to, a programmed microprocessor, a micro-controller, a peripheral integrated circuit element, and t other devices or arrangements of devices that are capable of implementing the steps that constitute the method of the present invention. In an embodiment of the present invention, the memory 1206 may store software for implementing an embodiment of the present invention. The computer system 1102 may have additional components. For example, the computer system 1102 includes one or more communication channels 1208, one or more input devices 1210, one or more output devices 1212, and storage 1214. An interconnection mechanism (not shown) such as a bus, controller, or network, interconnects the components of the computer system 1202. In an embodiment of the present invention, operating system software (not shown) provides an operating environment for various software executing in the computer system 1202 and manages different functionalities of the components of the computer system 1202.

The communication channel(s) 1208 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 1210 may include, but not limited to, a keyboard, mouse, pen, joystick, trackball, a voice device, a scanning device, touch screen or any another device that is capable of providing input to the computer system 1202. In an embodiment of the present invention, the input device(s) 1210 may be a sound card or similar device that accepts audio input in analog or digital form. The output device(s) 1212 may include, but not limited to, a user interface on CRT or LCD, printer, speaker, CD/DVD writer, or any other device that provides output from the computer system 1202.

The storage 1214 may include, but not limited to, magnetic disks, magnetic tapes, CD-ROMs, CD-RW, DVDs, flash drives or any other medium which can be used to store information and can be accessed by the computer system 122. In an embodiment of the present invention, the storage 1214 contains program instructions for implementing the described embodiments.

The present invention may suitably be embodied as a computer program product for use with the computer system 1202. The method described herein is typically implemented as a computer program product, comprising a set of program instructions which is executed by the computer system 1202 or any other similar device. The set of program instructions may be a series of computer readable codes stored on a tangible medium, such as a computer readable storage medium (storage 1214), for example, diskette, CD-ROM, ROM, flash drives or hard disk, or transmittable to the computer system 1202, via a modem or other interface device, over either a tangible medium, including but not limited to optical or analogue communications channel(s) 1208. The implementation of the invention as a computer program product may be in an intangible form using wireless techniques, but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A system for optimizing energy efficiency and carbon emissions of software-based applications within an information-technology ecosystem, the system comprising:
a memory storing program instructions;
a processor executing program instructions stored in the memory and configured to execute an energy optimisation engine to:
retrieve a first training data, a second training data, a third training data, a fourth training data and a user input data for training an Artificial Intelligence (AI)-based model to generate a set of recommendations;
process, by the AI-based model, the generated set of recommendations by creating vector embeddings;
compare a verified set of the generated recommendations against a desired set of recommendations to obtain a modified set of recommendations;
fetch a workload data, real-time monitoring data, benchmark data and a set of emission data;
generate an estimated carbon footprint data and estimated energy consumption data based on the modified set of recommendations, the workload data, monitoring data, benchmark data, and the set of emission data; and
generate an output data based on the generated estimated carbon footprint data and estimated energy consumption data for validating technologies, hardware and cloud services relating to sustainability and energy consumption.

2. The system as claimed in claim 1, wherein the first training data comprises:
data relating to a set of sustainable information technology practices, wherein each of the sustainable practices is associated with a corresponding weight that represents energy consumption information; and
data relating to architectural guidelines, data design and accessibility design.

3. The system as claimed in claim 1, wherein the second training data comprises:
data related to one or more functional requirements;
user story mapping data for identifying and understanding end-user's requirements;
use case diagrams that aid in visualising interactions between actors; and
sequence diagrams that depict interactions between objects or components over time.

4. The system as claimed in claim 1, wherein the third training data comprises:
instructions associated with non-functional requirements, performance data type relating to performance in terms of handling of concurrent user requirements efficiently, scalability parameters, security inputs such as implementation of secure authentication mechanisms;
instructions for improving reliability that helps in minimising downtime by using redundant server and failover mechanisms;
instructions for improving reliability include regularly backing up data to prevent data loss;
instructions in terms of improving maintainability of modular components for easy updates and related bug fixes;
instructions for usability that relates to ensuring an initiative-based user interface with clear navigation;
instructions related to system architecture patterns that relates to microservices architecture; and
instructions related to system architecture that relates to breaking down of the system into smaller, independent services.

5. The system as claimed in claim 1, wherein the fourth training data comprises:
data in form of instructions regarding application performance requirements; and
a data structure data that relates to energy impact in terms of high, medium and low.

6. The system as claimed in claim 1, wherein the processor is configured to receive the input data from a user in the form of a natural language query via a user input unit, wherein the natural language query is in the form of a prompt.

7. The system as claimed in claim 1, wherein the generated set of recommendations comprises:
a first recommendation data including recommendations relating to identifying optimal architecture/design, cloud/on premise deployment, microservice/container-based deployment, monolithic/distributed deployment, UI/UX designs and web designs;
a second recommendation data including recommendations relating to utilising sustainable technology for server types, hardware equipment, server brand, software, database and middleware;
a third recommendation data including recommendations related to developing and implementing software-based applications with respect to parameters such as complexity, performance and cost;
a fourth recommendation data including recommendations for selecting coding language and techniques for coding per language;
a fifth recommendation data including recommendations related to optimised storage resource types suitable for improving functional and performance requirements;
a sixth recommendation data including information related to compute parameter for computing resource types suitable for improving functional and performance requirements; and
a seventh recommendation data including information relating to sustainable cloud service operation for providing recommendations on using cloud services for improving efficiency.

8. The system as claimed in claim 1, wherein the processor is configured to verify the generated set of recommendations against pre-determined data sources based on factors including inaccurate or outdated external information, insufficient fine-tuning of underlying models, bias present in the training data, security or privacy concerns and over-reliance on single or limited data sources.

9. The system as claimed in claim 1, wherein the AI-based model uses retrieval augmented generation technique and is configured to:
gather information from external databases or knowledge sources;
select optimal architecture configurations, embedding techniques, and vector storage solutions;
filter external data and fine-tune generated set of recommendations;
achieve fine-tuning of the set of recommendations by integrating advanced retrieval mechanisms with dynamic adjustments of the AI-based model; and
create the vector embeddings to capture complex semantic relationships, systematically filter external data, wherein the AI-based model is continuously update based on real-world data and user feedback, and wherein the created embeddings relate to dense, continuous vectors that represent text in a high-dimensional space.

10. The system as claimed in claim 1, wherein the desired set of recommendations includes:
recommendations related to computing resource types that are suitable for improving functional and performance requirements;
recommendations on using cloud services for improving efficiency; and
recommendations related to fine-tuning of the generated set of recommendations by filtering out irrelevant data.

11. The system as claimed in claim 1, wherein the benchmark data relates to evaluated power and performance characteristics of single server and multi-node server, wherein the benchmark data is used to compare power and performance characteristics among different servers and serves as a toolset for improving server efficiency.

12. The system as claimed in claim 1, wherein the set of emission data comprises:
cloud services data that includes resource data for compute memory, storage, network services with detail sizing and scaling;
resource energy data for energy consumption in terms of watts with usage levels of 100%, 75%, 50%, 25%, 10%, 0% per service; and
emission per unit of service in terms of size, compute power and throughput.

13. The system as claimed in claim 1, wherein the set of emission data comprises carbon emission data, the carbon emission data is generated via Software Carbon Intensity (SCI) index, wherein the SCI index=((E*I)+M) per R where E represents energy consumed by software in kWh, I represents carbon emitted per kWh of energy, M represents embodied carbon emissions from creation of hardware that a software is running on and R is a functional unit in terms of how software scales.

14. A method for optimizing energy efficiency and carbon emissions of software-based applications within an information-technology ecosystem, the method comprising steps of:
retrieving a first training data, second training data, third training data, fourth training data and a user input data for training an Artificial Intelligence (AI)-based model to generate a set of recommendations;
processing the generated set of recommendations by creating vector embeddings using the AI-based model;
comparing a verified set of generated recommendations against a desired set of recommendations to obtain a modified set of recommendations;
fetching a workload data, real time monitoring data, benchmark data and a set of emission data;
generating an estimated carbon footprint data and estimated energy consumption data based on the modified set of recommendations, the workload data, monitoring data, benchmark data, and the set of emission data; and
generating an output data based on the generated estimated carbon footprint data and estimated energy consumption data for validating technologies, hardware and cloud services relating to sustainability and energy consumption.

15. The method as claimed in claim 14, wherein the first training data comprises:
data relating to a set of sustainable information technology practices, wherein each set of sustainable practice is associated with a corresponding weight that represents energy consumption information; and
data relating to architectural guidelines, data design and accessibility design.

16. The method as claimed in claim 14, wherein the second training data comprises:
data related to one or more functional requirements;
user story mapping data for identifying and understanding end-user's requirements;
use case diagram data that aid in visualising interactions between actors; and
sequence diagram data that depict interactions between objects or components over time.

17. The method as claimed in claim 14, wherein the third training data comprises:
instructions associated with non-functional requirements, performance data type relating to performance in terms of handling of concurrent user requirements efficiently, scalability parameters, security inputs such as implementation of secure authentication mechanisms;
instructions for improving reliability that helps in minimising downtime by using redundant server and failover mechanisms;
instructions for improving reliability include regularly backing up data to prevent data loss;
instructions in terms of improving maintainability of modular components for easy updates and related bug fixes;
instructions for usability that relates to ensuring an initiative-based user interface with clear navigation;
instructions related to system architecture patterns that relates to microservices architecture; and
instructions related to system architecture relate to breaking down of the system into smaller, independent services.

18. The method as claimed in claim 14, wherein the fourth training data comprises:
data in the form of instructions regarding application performance requirements; and
a data structure data that relates to energy impact in terms of high, medium and low.

19. The method as claimed in claim 14, wherein the generated set of recommendations comprises:
a first recommendation data including recommendations relating to identifying optimal architecture/design, cloud/on premise deployment, microservice/container-based deployment, monolithic/distributed deployment, UI/UX designs and web designs;
a second recommendation data including recommendations relating to utilising sustainable technology for server types, hardware equipment, server brand, software, database and middleware;
a third recommendation data including recommendations related to developing and implementing software-based applications with respect to parameters such as complexity, performance and cost;
a fourth recommendation data including recommendations for selecting coding language and techniques for coding per language;
a fifth recommendation data including recommendations related to optimised storage resource types suitable for improving functional and performance requirements;
a sixth recommendation data that includes information related to compute parameter for computing resource types suitable for improving functional and performance requirements; and
a seventh recommendation data that includes information relating to sustainable cloud service operation for providing recommendations on using cloud services for improving efficiency.

20. The method as claimed in claim 14, wherein the AI-based model is configured to:
select optimal architecture configurations, embedding techniques, and vector storage solutions;
filter external data and fine-tune generated set of recommendations;
achieve fine-tuning of set of recommendations by integrating advanced retrieval mechanisms with dynamic AI model adjustments; and
create vector embeddings to capture complex semantic relationships, systematically filter external data, wherein the AI-based model is continuously updated based on real-world data and user feedback, and wherein the created vector embeddings relate to dense, continuous vectors that represent text in a high-dimensional space.

21. The method as claimed in claim 14, wherein the desired set of recommendations include:
recommendations related to computing resource types that suitable for improving are functional and performance requirements;
recommendations on using cloud services for improving efficiency; and
recommendations related to fine-tuning of the generated set of recommendations by filtering out irrelevant data.

22. The method as claimed in claim 14, wherein the benchmark data relates to evaluated power and performance characteristics of single server and multi-node server, wherein the benchmark data is used to compare power and performance characteristics among different servers and serves as a toolset for improving server efficiency.

23. The method as claimed in claim 14, wherein the set of emission data comprises:
cloud services data that includes resource data for compute memory, storage, network services with detail sizing and scaling;
resource energy data for energy consumption in terms of watts with usage levels of 100%, 75%, 50%, 25%, 10%, 0% per service; and
emission per unit of service in terms of size, compute power and throughput.

24. The method as claimed in claim 14, wherein the set of emission data comprises carbon emission data, the carbon emission data is generated via Software Carbon Intensity (SCI) index, wherein the SCI index=((E*I)+M) per R where E represents energy consumed by software in kWh, I represents carbon emitted per kWh of energy, M represents embodied carbon emissions from creation of hardware that a software is running on and R is a functional unit in terms of how software scales.

25. A computer program product comprising:
a non-transitory computer-readable medium having computer-readable program code stored thereon, the computer-readable program code comprising instructions that, when executed by a processor, cause the processor to:
retrieve a first training data, second training data, third training data, fourth training data and a user input data for training an artificial intelligence based model to generate a set of recommendations;
process the generated set of recommendations by creating vector embeddings using the AI-based model;
compare a verified set of the generated recommendations against a desired set of recommendations to obtain a modified set of recommendations;
fetch a workload data, real time monitoring data, benchmark data and a set of emission data;
generate an estimated carbon footprint data and estimated energy consumption data based on the modified set of recommendations, the workload data, monitoring data, benchmark data, and the set of emission data; and
generate an output data based on the generated estimated carbon footprint data and estimated energy consumption data for validating technologies, hardware and cloud services relating to sustainability and energy consumption.
